(19) United States
(12) Patent Application Publication
(10) Pub. No.: US 2009/0092701 A1
(43) Pub. Date: Apr. 9, 2009

(54) Auxiliary Carriage Combined with an Auxiliary Carriage Actuator and a Multi-Stack Molding Machine Incorporating Same

(75) Inventors: Robert Dietrich Schad, North York (CA); Adrian Peter Looije, Aurora (CA); John Disimone, Woodbridge (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/867,705

(22) Filed: Oct. 5, 2007

(51) Int. Cl. B29C 45/17

(52) U.S. Cl. 425/185

(57) ABSTRACT

According to embodiments of the present invention, there are provided an auxiliary carriage combined with an auxiliary carriage actuator and a multi-stack molding machine incorporating same. For example, an auxiliary carriage for use in a multi-level molding machine is disclosed. The auxiliary carriage comprises a support structure configured to accept, in use, an auxiliary mold assembly; an auxiliary carriage actuator configured to be operatively coupled, in use, to the support structure, to a main carriage of the multi-level molding machine and to one of a fixed platen and a movable platen to actuate, in use, the auxiliary carriage in unison with the main carriage.

### TECHNICAL FIELD

The present invention generally relates to, but is not limited to multi-stack mold and more specifically, but not limited to, an auxiliary carriage combined with an auxiliary carriage actuator and a multi-stack molding machine incorporating same.

### BACKGROUND OF THE INVENTION

Molding is a process by virtue of which a molded article can be formed from molding material by using a molding system. Various molded articles can be formed by using the molding process, such as an injection molding process. One example of a molded article that can be formed, for example, from polyethylene terephthalate (PET) material is a preform that is capable of being subsequently blown into a beverage container, such as, a bottle and the like. Another example of a molded article that can be formed by the injection molding process is a thinwall container that can be used, for example, for storing food items and the like.

One consideration for an economical operation of a molding machine is a number of molded articles produced in a given time interval or, in other words, productivity of the molding system. Typically, productivity of the molding system is calculated in molded articles produced per interval of time, such as molded articles per minute or molded articles per second.

Various solutions have been tried in the prior art to increase productivity of the molding machine. Some examples of such solutions include various post-mold treatment arrangements, speed up packages for various parts of the molded machine and the like. One example of another solution for increasing productivity is a multi-stack molding machine. Within the multi-stack molding machine, the molding machine has a plurality of axially arranged mold assemblies, each defining one or more molding cavities. The plurality of axially arranged mold assemblies is mounted between a movable platen and a fixed platen and is actuated, in unison, between a clamp open and clamp closed positions by an actuator system. In other words, the movement of the movable platen actuates, in unison, the plurality of axially arranged mold assemblies between the open and the closed positions.

An example of a multi-stack molding machine is disclosed in the U.S. Pat. No. 5,707,666 issued to DiSimone et al. on Jan. 13, 1998 and assigned to the Assignee of the present patent application. DiSimone et al. teaches an injection molding machine having a plurality of axially arranged mold stations including structure for supporting sets of mold plates and a mechanism for opening, closing and overstroking mold plates.

US patent application 2006/0082028 by DiSimone published on Apr. 20, 2006 teaches a method of loading a moldset having a core plate and a cavity plate into an injection molding machine. The method comprises the steps of latching a cavity plate to a core plate using a removable latch, guiding the core plate into an open mold along a face in the mold while maintaining separation between the face and the core plate and maintaining the cavity plate spaced from hot runner nozzles in a hot runner in the mold, closing the mold to engage the cavity plate with the hot runner nozzles, securing the cavity plate to the hot runner, removing the latch between the cavity plate and the core plate, and opening the mold. The face may be a face of a movable platen or a back surface of a hot runner.

### SUMMARY OF THE INVENTION

According to a first broad aspect of the present invention, there is provided an auxiliary carriage for use in a multi-level molding machine. The auxiliary carriage comprises a support structure configured to accept, in use, an auxiliary mold assembly; an auxiliary carriage actuator configured to be operatively coupled, in use, to the support structure, to a main carriage of the multi-level molding machine and to one of a fixed platen and a movable platen to actuate, in use, the auxiliary carriage in unison with the main carriage.

According to a second broad aspect of the present invention, there is provided a clamp assembly for use in a multi-level molding machine. The clamp assembly comprises a fixed platen and a movable platen configured to be actuated, in use, relative to the fixed platen; the fixed platen and the movable platen configured to accept, in use, a respective platen-mountable mold assembly; a main carriage configured to accept, in use, a main mold assembly; a first auxiliary carriage and a second auxiliary carriage configured to accept in use, a first auxiliary mold assembly and a second auxiliary mold assembly, respectively; a main carriage actuator operatively coupled to the main carriage, the movable platen and the fixed platen; a pair of auxiliary carriage actuators, each being operatively coupled to the respective first and second auxiliary carriages, to the main carriage and one of the movable platen and the fixed platen, whereby a plurality of molding stations is defined between the respective platen-mountable mold assembly, main mold assembly, the first auxiliary mold assembly and the second auxiliary mold assembly; and whereby actuation of the movable platen to and from the fixed platen actuates, in unison, movement of the main carriage, the first auxiliary carriage and the second auxiliary carriage.

According to a third broad aspect of the present invention, there is provided an auxiliary carriage actuator for use with an auxiliary carriage within a multi-level molding machine. The auxiliary carriage actuator comprises an auxiliary support pivotally mountable, in use, onto the auxiliary carriage; a first auxiliary link and a second auxiliary link, each pivotally mountable onto the auxiliary support; the first auxiliary link comprising a first coupler, pivotally mountable to the first auxiliary link, configured to be coupled, in use, to the main carriage, the second auxiliary link comprising a second coupler, pivotally mountable to the second auxiliary link, configured to be coupled, in use, to one of a fixed platen and a movable platen.

### DESCRIPTION OF THE DRAWINGS

A better understanding of the embodiments of the present invention (including alternatives and/or variations thereof) may be obtained with reference to the detailed description of the embodiments along with the following drawings, in which:

FIG. 1 depicts a portion of a clamp assembly that includes a fixed platen, a movable platen and a carriage sub-system arranged therebetween; all implemented according to a non-limiting embodiment of the present invention and shown in a clamp closed position.

FIG. 2 depicts the clamp assembly of FIG. 1 with a main carriage actuator mounted onto a main carriage of the carriage sub-system, implemented according to a non-limiting embodiment of the present invention and shown in a clamp closed position.

FIG. 3 depicts a schematic perspective view of an auxiliary carriage of the carriage sub-system of FIG. 1 with an auxiliary carriage actuator mounted thereupon, implemented in accordance with a non-limiting embodiment of the present invention.

FIG. 4 is a cross section taken along line A of FIG. 1, depicting a rail and a roller associated with the main carriage of the carriage sub-system of FIG. 1, implemented in accordance with a non-limiting embodiment of the present invention.

FIG. 5 is a cross section taken along lines B-B of FIG. 1, depicting the auxiliary carriage and the auxiliary carriage actuator of FIG. 3 mounted onto the clamp assembly of FIG. 1.

The drawings are not necessarily to scale and are may be illustrated by phantom lines, diagrammatic representations and fragmentary views. In certain instances, details that are not necessary for an understanding of the embodiments or that render other details difficult to perceive may have been omitted.

### DETAILED DESCRIPTION OF EMBODIMENTS

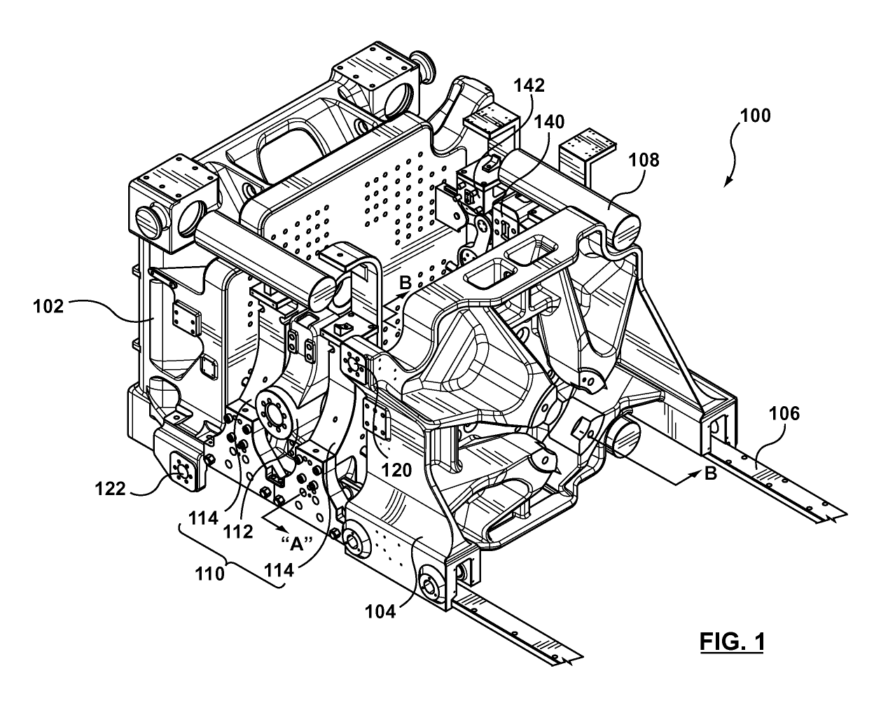

With reference to FIG. 1, there is depicted a clamp assembly 100 implemented according to a non-limiting embodiment of the present invention. Those skilled in the art will readily appreciate that FIG. 1 only shows a portion of the clamp assembly 100. Omitted from FIG. 1 are a clamp actuator and a clamp base, both of these elements known to those skilled and the art and, as such, have been omitted from FIG. 1 for the sake of simplicity of illustration. The clamp assembly 100 comprises a fixed platen 102 and a movable platen 104. The movable platen 104 is movable along a pair of rails 106 and a plurality of tie bars 108 (only three of which are shown). The movable platen 104 can be moved by any known means, such as by means of stroke cylinders (not shown) or by any other suitable means.

Also depicted in FIG. 1 is a carriage sub-system 110. Generally speaking, the purpose of the carriage sub-system 110 is to accept, in use, mold assemblies (not depicted). For the avoidance of doubt, it should be understood that the term “mold assembly” is meant to denote a mold plate for accepting one or more mold inserts (such as cavity inserts or core inserts), as well as some or all of: a hot runner associated with the mold plate carrying cavity inserts; stripper plate and stripper plate components associated with the mold plate carrying core inserts and other components typically found in mold assembly known to those skilled in the art.

The carriage sub-system 110 comprises a main carriage 112 and two instances of an auxiliary carriage 114. It can be seen in FIG. 1, that both the main carriage 112 and each instance of the auxiliary carriage 114 comprises a pair thereof, each instance of the pair located at opposite sides of the clamp assembly 100 relative to a plane that traverses an operational axis (not separately depicted) of the clamp assembly 100. Put another way, each instance of the pair is associated with a given one of the pair of rails 106. Each of the main carriage 112 and the auxiliary carriage 114 comprises a portion (not separately numbered) configured to be mounted on the given one of the pair of rails 106.

Furthermore, it should be appreciated that even though, the main carriage 112 and the auxiliary carriage 114 have been described as part of the carriage sub-system 110, this is not meant to denote that both the main carriage 112 and the auxiliary carriage 114 need to come as part of the package, need to come from the same vendor or need to be delivered/installed at the same time. Quite the contrary, the main carriage 112 and/or the auxiliary carriage 114 may be supplied from different sources, at different times and may or may not be supplied as part of a package.

For example, in some embodiments of the present invention, both the main carriage 112 and the auxiliary carriage 114 (in whatever arrangement of instances it may come) may be retrofitted into the clamp assembly 100 already in use at a given entity. In other embodiments of the present invention, it is contemplated that the main carriage 112 and/or the auxiliary carriage 114 (in whatever arrangement of instances it may come) and/or other components of the carriage sub-system 110 may provided on a need-be basis and not necessarily from a same source of the clamp assembly 100.

Generally speaking, the purpose of the carriage sub-system 110 is (i) to accept, in use, a mold assembly (not depicted); and (ii) to enable actuation of the accepted mold assembly (not depicted) relative the pair of rails 106. More specifically, it can be said that the main carriage 112 comprises a support structure 140 that is configured to accept, in use, a main mold assembly (not depicted) and the auxiliary carriage 114 comprises a support structure 142 that is configured to accept, in use, an auxiliary mold assembly (not depicted). For the avoidance of doubt, it should be expressly understood that the terms “main” and “auxiliary” are meant to denote relationship between various carriages and molds (relative to each other) used within the clamp assembly 100. The movable platen 104 and the fixed platen 102 are also configured to accept, in use, mold assemblies (which can be broadly referred to as platen-mountable mold assemblies).

As can be appreciated by those skilled in the art, within the non-limiting embodiment of FIG. 1, in use (when the main mold assembly, the auxiliary mold assemblies and the platen-mountable mold assemblies are mounted onto the main carriage 112, auxiliary carriages 114 and the movable platen 104/fixed platen 102, respectively), there are provided four molding stations (not depicted) disposed between a complementary sets of mold assemblies. Specific arrangements of core inserts, cavity inserts, associated hot runners and stripper plates (or other de-molding means) are known to those skilled in the art and need not be discussed here at any length. Accordingly, within the embodiment of FIG. 1, it can be said that the clamp assembly 100, in use, is configured to provide a four-level molding stack and, accordingly, a molding machine (not depicted) that accepts, in use, the clamp assembly 100 of FIG. 1 can be thought of to as a “four-level molding machine” or, generally, as a “multi-level molding machine”.

One or more molding cavities are defined between each of the complementary sets of mold assemblies. A shape of the molding cavities generally correspond to the final shape of molded articles to be produced. In an example non-limiting implementation, the mold assembly accepted within the clamp assembly 100 can be used for producing packaging items (ex. thinwall containers and the like). However, this need not be so in every embodiment of the present invention. Other types of mold assemblies can be accepted within the clamp assembly 100, such as mold assemblies for producing thinwall molded articles, thickwall molded articles, preforms, non-packaging items (such as, for example, call phone parts, car parts, etc).

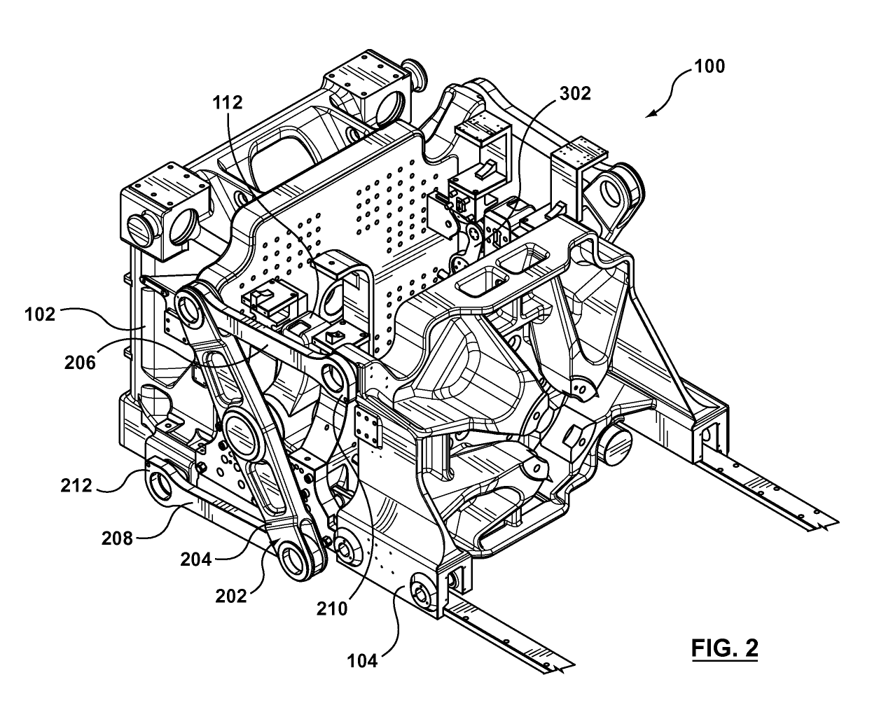

With continued reference to FIG. 1 and with further reference to FIG. 2, the main carriage 112 is associated with a main carriage actuator 202. The main carriage actuator 202 comprises a crank mechanism (not separately numbered) that, in turn, comprises a main support 204 pivotally mountable onto the support structure 140 of the main carriage 112. The main carriage actuator 202 further comprises a first main link 206 and a second main link 208. Each of the first main link 206 and the second main link 208 is pivotally mountable to the main support 204.

The first main link 206 is configured to be coupled to the movable platen 104. To that extent, the first main link 206 comprises a first actuator coupling interface 210 and the movable platen 104 is provided with a first platen coupling interface 120 (FIG. 1) complementary to the first actuator coupling interface 210. The second main link 208 is configured to be coupled to the fixed platen 102. To that extent, the second main link 208 comprises a second actuator coupling interface 212 and the fixed platen 102 is provided with a second platen coupling interface 122 (FIG. 1) complementary to the second actuator coupling interface 212. As can be seen in FIG. 2, the first actuator coupling interface 210 and the second actuator coupling interface 212 are substantially identical and, similarly, the first platen coupling interface 120 and the second platen coupling interface 122 are substantially identical. Accordingly, within these embodiments, couplings of the first main link 206 and the second main link 208 can be reversed and, as such, the first main link 206 can be coupled to the fixed platen 102 and the second main link 208 can be coupled to the movable platen 104.

Those skilled in the art will appreciate configuration of suitable fasteners (such as bolts and the like) that can be used for coupling the first actuator coupling interface 210 to the first platen coupling interface 120 and the second actuator coupling interface 212 to the second platen coupling interface 122.

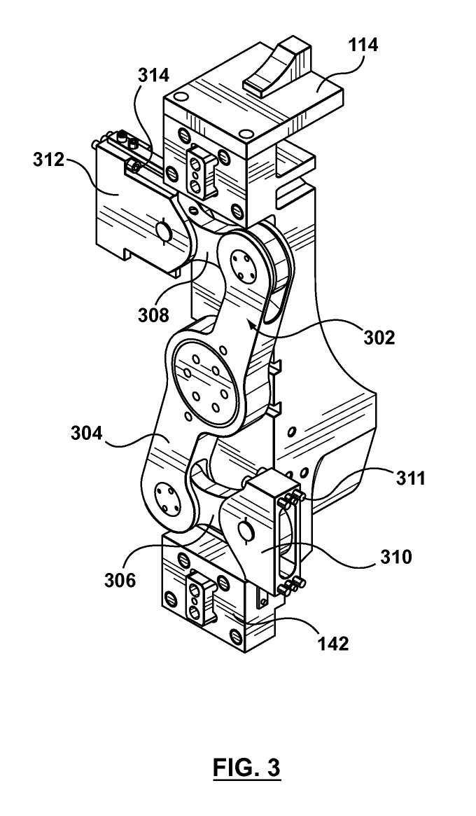

With continued reference to FIG. 1 and with reference to FIG. 3, the auxiliary carriage 114 is associated with an auxiliary carriage actuator 302. The auxiliary carriage actuator 302 comprises a crank mechanism (not separately numbered) that, in turn, comprises an auxiliary support 304 pivotally mountable onto the support structure 142 of the auxiliary carriage 114. As is clearly seen in FIG. 3, the auxiliary support 304 is pivotally mounted onto substantially a center of the support structure 142. The auxiliary carriage actuator 302 further comprises a first auxiliary link 306 and a second auxiliary link 308. Each of the first auxiliary link 306 and the second auxiliary link 308 is pivotally mounted to the auxiliary support 304.

The first auxiliary link 306 is configured to be coupled to the main carriage 112. The second auxiliary link 308 is configured to be coupled to one of the movable platen 104 or the fixed platen 102. To that extent, the first auxiliary link 306 is provided with a first coupler 310, pivotally mounted to the first auxiliary link 306, that is configured to be attached to the main carriage 112 by means of fasteners 311 (such as bolts and the like). Similarly, the second auxiliary link 308 is provided with a second coupler 312, pivotally mounted to the second auxiliary link 308, that is configured to be attached to the one of the movable platen 104 or the fixed platen 102 by means of fasteners 314 (such as bolts and the like). Even though within the specific non-limiting embodiment depicted in FIG. 3, the first coupler 310 and the second coupler 312 are depicted as having different dimensions, this need not be so in every embodiment of the present invention. In alternative embodiments of the present invention, the first coupler 310 and the second coupler 312 can be implemented as substantially identical structures.

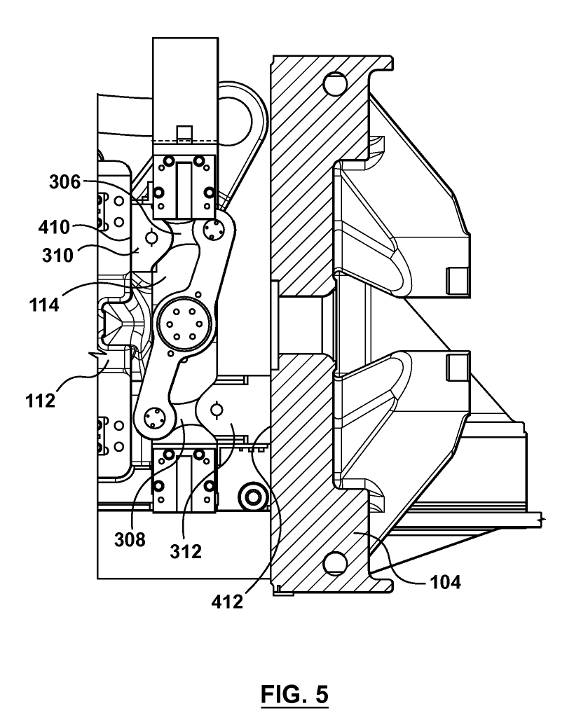

As is best seen in FIG. 5, where there is shown the second coupler 312 coupled to the movable platen 104 and the first coupler 310 coupled to the main carriage 112, there is defined a first connection interface 410 between the first coupler 310 and the main carriage 112 and a second connection interface 412 between the second coupler 312 and the movable platen 104. In other words, it can be said that the second coupler 312 is directly coupled to the movable platen 104 and the first coupler 310 is directly coupled to the main carriage 112.

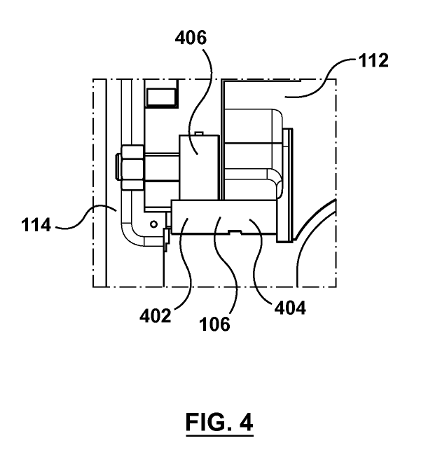

As is best seen in FIG. 2, the main carriage actuator 202 is provided on an outside portion of the carriage sub-system 110 and the auxiliary carriage actuator 302 is provided on an inside portion of the carriage sub-system 110. Similarly, it can be said that the auxiliary carriage 114 is operable to move on an outside portion of a respective one of the pair of rails 106 and the main carriage 112 is configured to move on an inside portion of the respective one of the pair of rails 106. This arrangement is best seen in FIG. 4, which depicts a cross section taken along line “A” in FIG. 1. FIG. 4 depicts one instance of the pair of rails 106 (referred to herein below as a rail 106). The rail 106 can be said to have two regions—an outside portion 402 and an inside portion 404. The outside portion 402 provided a path of travel to the auxiliary carriage 114 and the inside portion 404 provides a path of travel to the main carriage 112.

The auxiliary carriage 114 comprises a roller 406 and the roller 406 is configured to roll along the outside portion 402 of the rail 106. Even though not shown in FIG. 4, the main carriage 112 comprises a roller similar to the roller 406 which is configured to roll along the inside portion 404 of the rail 106. This arrangement allows and as is best seen in FIG. 1, for the main carriage 112 and the auxiliary carriages 114 to “nest” relative to each other in a “clamp closed position” (as is the case in FIG. 1). In other words, the main carriage 112 and the auxiliary carriages 114 can be said to be “nestable” within each other in the clamp closed position.

In operation, the movable platen 104 is urged towards and away relative to the fixed platen 102 (for example, by means of stroke cylinders which are not shown or by any other suitable means). In FIG. 1, the clamp assembly 100 is shown in the clamp closed position. In the clamp closed position, melt can be injected into molding cavities defined within the aforementioned molding stations. In the clamp closed position, known hold and in-mold cooling cycles can be implemented. The movement of the movable platen 104 away from the fixed platen 102 (i.e. towards a clamp open position) causes movement of the carriage sub-system 110 relative to the fixed platen 102. More specifically, via the main carriage actuator 202, relative movement is impacted onto the main carriage 112. Movement of the main carriage 112, on the other hand, via the auxiliary carriage actuators 302 imparts relative movement onto the auxiliary carriages 114. In the clamp open position, molded articles produced during the aforementioned clamp closed position can be de-molded from the aforementioned molding stations. Various de-molding techniques are known to those skilled in the art and may include stripper plates, swing chutes, robots and the like. The movable platen 104 is then urged into the clamp closed position, again, and the relative movement is impacted, albeit in reverse.

A technical effect of some embodiments of the present invention may include provision of an “all-machine-based” carriage sub-system 110, which can accept in use, mold assembly and may be retrofitted into an existing clamp assembly 100. Another technical effect of some embodiments of the present invention, may include provision of a carriage sub-system 110 which is independent from the mold assemblies or, in other words, multiple standard mold assemblies may be “dropped” into the carriage sub-system 110. Another technical effect of embodiments of the present invention, may include provision of a carriage sub-system with actuators that provide for a more even force distribution due at least partially to specific arrangement of auxiliary carriage actuator 302 taught in embodiments of the present invention. It should be noted that not all technical effects need to be recognized, in their entirety, in each and every embodiment of the present invention.

The description of the embodiments provides examples of the present invention, and these examples do not limit the scope of the present invention. The concepts described above may be adapted for specific conditions and/or functions, and may be further extended to a variety of other applications that are within the scope of the present invention. Having thus described the embodiments, it will be apparent that modifications and enhancements are possible without departing from the concepts as described. Therefore, what is to be protected by way of letters patent are limited only by the scope of the following claims:

What is claimed is:

1. An auxiliary carriage for use with a multi-level molding machine, the auxiliary carriage comprising:
a support structure configured to accept, in use, an auxiliary mold assembly;
an auxiliary carriage actuator configured to be operatively coupled, in use, to the support structure, to a main carriage of the multi-level molding machine and to one of a fixed platen and a movable platen of the multi-level molding machine to actuate, in use, the auxiliary carriage in unison with the main carriage.

2. The auxiliary carriage of claim 1, wherein said auxiliary carriage actuator comprises:
an auxiliary support pivotally mountable onto said support structure;
a first auxiliary link and a second auxiliary link each pivotally mounted onto the auxiliary support;
the first auxiliary link configured for attachment to the main carriage; and
the second auxiliary link configured for attachment to one of the fixed platen and the movable platen.

3. The auxiliary carriage of claim 2, wherein said first auxiliary link comprises a first coupler, pivotally mountable to the first auxiliary link, configured to be coupled to the main carriage.

4. The auxiliary carriage of claim 3, wherein said first coupler is configured to define, in use, a first connection interface with the main carriage.

5. The auxiliary carriage of claim 2, wherein said second auxiliary link comprises a second coupler, pivotally mountable to the second auxiliary link, configured to be coupled to the one of the fixed platen and the movable platen.

6. The auxiliary carriage of claim 5, wherein said second coupler is configured to define, in use, a second connection interface with one of the fixed platen and the movable platen.

7. The auxiliary carriage of claim 1, wherein said support structure is further configured to be mountable onto a rail of the multi-level molding machine.

8. A clamp assembly for use in a multi-level molding machine, the clamp assembly comprising:
a fixed platen and a movable platen configured to be actuated, in use, relative to the fixed platen; the fixed platen and the movable platen configured to accept, in use, a respective platen-mountable mold assembly;
a main carriage configured to accept, in use, a main mold assembly;
a first auxiliary carriage and a second auxiliary carriage configured to accept in use, a first auxiliary mold assembly and a second auxiliary mold assembly, respectively;
a main carriage actuator operatively coupled to the main carriage, the movable platen and the fixed platen;
a pair of auxiliary carriage actuators, each being operatively coupled to the respective first and second auxiliary carriages, to the main carriage and one of the movable platen and the fixed platen,
whereby a plurality of molding stations is defined, in use, between the respective platen-mountable mold assembly, main mold assembly, the first auxiliary mold assembly and the second auxiliary mold assembly; and whereby
actuation of the movable platen to and from the fixed platen actuates, in unison, movement of the main carriage, the first auxiliary carriage and the second auxiliary carriage.

9. The clamp assembly of claim 8, wherein each of said pair of auxiliary carriage actuators comprises:
an auxiliary support pivotally mountable onto one of said respective first and second auxiliary carriages;
a first auxiliary link and a second auxiliary link each pivotally mounted onto the auxiliary support;
the first auxiliary link configured for attachment to the main carriage; and
the second auxiliary link configured for attachment to one of the fixed platen and the movable platen.

10. The clamp assembly of claim 9, wherein said first auxiliary link comprises a first coupler, pivotally mountable to the first auxiliary link, configured to be coupled to the main carriage.

11. The clamp assembly of claim 10, further comprising a first connection interface defined, in use, between the first coupler and the main carriage.

12. The clamp assembly of claim 9, wherein said second auxiliary link comprises a second coupler, pivotally mountable to the second auxiliary link, configured to be coupled to the one of the fixed platen and the movable platen.

13. The clamp assembly of claim 12, further comprising a second connection interface defined, in use, between the second coupler and one of the fixed platen and the movable platen.

14. The clamp assembly of claim 9, wherein said main carriage actuator comprises:
a main support pivotally mountable onto the main carriage;
a first main link and a second main link, each pivotally mounted onto said main support;
the first main link being configured to couple to the movable platen;
the second main link being configured to couple to the fixed platen.

15. The clamp assembly of claim 14, wherein
the first main link comprises a first actuator coupling interface;
the movable platen 104 comprises a first platen coupling interface complementary to said first actuator coupling interface.

16. The clamp assembly of claim 14, wherein
the second main link comprises a second actuator coupling interface;
the fixed platen comprises a second platen coupling interface complementary to said second actuator coupling interface.

17. The clamp assembly of claim 9, wherein said main carriage, said first auxiliary carriage and said second auxiliary carriage are configured to be nestable within each other in a clamp closed position.

18. The clamp assembly of claim 9, further comprising a pair of rails, each of the pair of rails comprising a first portion and a second portion, the first portion for providing a path of travel to said first auxiliary carriage and said second auxiliary carriage and the second portion for providing a path of travel to said main carriage.

19. The clamp assembly of claim 9, further comprising a pair of rails, wherein
the main carriage comprises a first instance of the main carriage and a second instance of the main carriage, each of the first instance and the second instance being associated with a respective one of the pair of rails; and wherein
the first auxiliary carriage comprises a first instance of the auxiliary carriage and a second instance of the auxiliary carriage, each of the first instance and the second instance being associated with the respective one of the pair of rails; and wherein
the second auxiliary carriage comprises a first instance of the auxiliary carriage and a second instance of the auxiliary carriage, each of the first instance and the second instance being associated with the respective one of the pair of rails; and wherein
in respect to the pair of rails
the first instance of the main carriage and the second instance of the main carriage are configured to be positioned, in use, on an outside portion relative to the respective one of the pair of rails;
and each of (i) the first instance of the first auxiliary carriage and the second auxiliary carriage and (ii) the second instance of the first auxiliary carriage and the second auxiliary carriage are configured to be positioned, in use, on an inside portion relative to the respective one of the pair of rails.

20. The clamp assembly of claim 9, further comprising the respective platen-mountable mold assembly, the main mold assembly, the first auxiliary mold assembly and the second auxiliary mold assembly.

21. The clamp assembly of claim 8, wherein each of a main carriage, a first auxiliary carriage and a second auxiliary carriage are configured to be mountable, in use, onto a respective rail of the multi-level molding machine.

22. The clamp assembly of claim 8, wherein each of said pair of auxiliary carriage actuators is directly coupled to the one of the movable platen and the fixed platen.

23. An auxiliary carriage actuator for use with an auxiliary carriage within a multi-level molding machine, the auxiliary carriage actuator comprising:
an auxiliary support pivotally mountable, in use, onto the auxiliary carriage;
a first auxiliary link and a second auxiliary link, each pivotally mountable onto the auxiliary support;
the first auxiliary link comprising a first coupler, pivotally mountable to the first auxiliary link, configured to be coupled, in use, to a main carriage.
the second auxiliary link comprising a second coupler, pivotally mountable to the second auxiliary link, configured to be coupled, in use, to one of a fixed platen and a movable platen.

24. The auxiliary carriage actuator of claim 23, wherein said first coupler is configured to define, in use, a first connection interface with the main carriage.

25. The auxiliary carriage of claim 23, wherein said second coupler is configured to define, in use, a second connection interface with one of the fixed platen and the movable platen.
